(19) United States
(12) Patent Application Publication
(10) Pub. No.: US 2003/0148164 A1
(43) Pub. Date: Aug. 7, 2003

(54) Efficient fuel cell water transport plates

(76) Inventors: Carol A. Koch, San Gabriel, CA (US); Prakash Mallya, Sierra Madre, CA (US); Evgueni Rosenbaoum, Arcadia, CA (US); Sriram Venkatasanthanam, Chino Hills, CA (US)

Correspondence Address: Attn: Michael B. Farber, Esq., OPPENHEIMER WOLFF & DONNELLY LLP, Suite 3800, 2029 Century Park East, Los Angeles, CA, 90067, US

(21) Appl. No.: 09/949,128

(22) Filed: Sep. 7, 2001

(51) Int. Cl. H01M 8/02

(52) U.S. Cl. 429/34; 264/614

(57) ABSTRACT

A fuel cell separator or water transport plate is formed of graphite, carbon fibers and an inert thermosetting hydrophilic binder. The materials may be in powdered form, and plates, preferably channeled, are formed using heat and pressure. The hydrophilic properties of the plates may be improved by immersion in an oxidizing bath followed by water rinsing. The active materials included in the plate are substantially limited to graphite, carbon fibers and the binder, and no additional hydrophilic coatings, materials or any high temperature processes are involved.

### FIELD OF THE INVENTION

The invention relates to improved separator plates or water transport plates (WTPs) for fuel cells, particularly for solid polymer electrolyte, or proton exchange membrane (PEM) type fuel cells.

### BACKGROUND OF THE INVENTION

Fuel cell power plants are electrochemical power sources for stationary and mobile applications, having fuel cells at their center. A fuel cell includes an anode, a cathode, and an electrolyte separating the two. Fuel reactant gas, typically a hydrogen rich stream, enters a support plate adjacent the anode (anode plate). Oxidant reactant gas, typically air, enters a support plate adjacent the cathode (cathode plate). As the hydrogen rich stream passes the anode plate, a catalyst located between the anode plate and the electrolyte oxidizes the hydrogen to hydrogen ions and electrons. The hydrogen ions migrate through the electrolyte to the cathode, while the electrons pass through an external electrical circuit to the cathode, producing useful work. Another catalyst on the cathode side of the electrolyte causes the oxygen to react with the hydrogen ions and electrons, thereby forming water. These reactions create an electrical potential across the fuel cell.

There are various types of fuel cells, depending on type of electrolyte. One type of fuel cell (a “PEM fuel cell”, to which the present invention pertains), includes a solid polymer electrolyte, also called a proton exchange membrane (PEM). The catalyst layers within a PEM fuel cell typically are attached to both sides of the membrane, in what is commonly called membrane electrode assembly or MEA. As noted above, while hydrogen ions pass through the MEA, the electrochemical reaction between the hydrogen ions, electrons, and oxidant reaction gas forms water within the cathode. This water is commonly called product water. In addition, water may accumulate in the cathode due to the drag of water molecules passing from the anode through the MEA along with hydrogen ions; this water is commonly called proton drag water.

One problem in the operation of PEM fuels cell is the management of water. The product water and drag water must be drawn away from the cathode side of the cells, and makeup water must be provided to the anode side of the cells in amounts that will prevent dry-out of the PEM, while avoiding flooding of the cathode side of the PEM. PEM fuel cells operate best when the electrolyte membrane is kept moist with water because the membrane will not operate efficiently when it is dry. The dragging of water through the PEM tends to dry the anode side and to create a water film on the cathode side. The cathode surface is further wetted by product water. Thus it is critical to the operation of the PEM fuel cell that the product water be continuously removed from the cathode side of the membrane while maintaining the anode side of the membrane wet to facilitate the electrochemical reaction and the membrane conductivity.

Due to their critical role in water management, the anode plates and cathode plates are often called “water transport plates” (WTP's). During PEM fuel cell operation the WTP's supply water locally to maintain humidification of the PEM, remove product water formed at the cathode, and supply water to the fuel cell to replenish water that has been lost by evaporation. Furthermore, the water transport plates remove by-product heat via a circulating coolant water stream (coolant water); conduct electricity from cell to cell in stacks of cells of a fuel cell power plant; provide a gas separator between adjacent cells; and provide passages for conducting the reactants through the cells.

Several approaches have been considered for dealing with the problem of removing product water and drag water from the cell stack active area in a fuel cell power plant. One approach is to evaporate the product water in the reactant gas stream. A second approach involves the entrainment of the product water and the drag water as liquid droplets in the fully saturated gas stream, so as to expel the product water and drag water from the active area of the fuel cell stack.

A third approach, which the present invention exemplifies, relies upon porosity of the water transport plates. Finely porous water transport plates provide passive cooling and water management control. A stack of water-saturated porous plates both cools the cells and prevents reactant cross-over between adjacent cells. The fine porous structure of the cathode plate moves water away from the cathode side of the PEM and into the coolant water stream. This porous plate approach requires that the porous plate body be filled with water at all times. If at any time the porous channels of such plates should become devoid of water, the reactant gas can also escape from the active area of the cells through the porous plate body. This would result in a lessening of cell efficiency with possible commingling of the reactant fuel and oxygen, and uncontrolled combustion.

Because of the requirement that porous water transport plates be electrically conductive, it is common to utilize carbon and graphite materials in such plates. It has been observed in using these materials in the porous-plate system for managing water, that the carbon bodies may operate satisfactorily for limited time, but that over time these materials become non-wetting for water or hydrophobic, and thus unable to prevent gas escape. To overcome this problem, various chemical modifications have been proposed to render carbon/graphite plate structures hydrophilic:

U.S. Pat. No. 6,258,476 B1 at column 3, lines 18-28, discusses the formation of carbon oxides on the surface of carbon particles through chemical or electrochemical oxidation. This technique is said to form hydroxylic or carboxylic acid species on carbon surfaces to render the surface areas hydrophilic. The '476 patent cites no patent or other publication, nor other specific art, and does not mention any plastic binder in combination with the carbon particles. The '476 patent states as to this art: “However, during operation of the cell the surface carbon oxides can be chemically reduced to reform the initial hydrophobic carbon surface. Thus, with time, during extended operation of the cell the porous body may empty of water and permit gas to escape.”

U.S. Pat. No. 4,175,165: Fuel Cell System Utilizing Ion Exchange Membranes and Bipolar Plates.

Conductive and gas impermeable bipolar plates are treated in a manner to render the plate surfaces hydrophilic in nature. This may be accomplished by coating the bipolar plate with a high surface area material, such as a colloidal silica. This helps to attract the water generated in the fuel cell away from the electrodes for subsequent removal.

Coating the plate surface with non-conductive materials such as colloidal silica undesirably increases the electrical resistance leading to reduced conductivity. It is also not so permanent since the coating can get leached out by the product water.

U.S. Pat. No. 5,840,414: Porous Carbon Body with Increased Wettability by Water.

Plate is formed from electrically conductive carbon particles bonded together to form a fine porous structure and the pores are partially filled and walls coated with suitable metal oxides such as tin oxide, aluminum oxide, niobium oxide, tantalum oxide, titanium oxide, ruthenium oxide to make them highly wettable by water.

The process as described in the patent involves several treatment steps involving several hours each and is not practical for fabricating the plate in a continuous fashion.

In formulating carbon/graphite based materials for fuel cell electrodes, two approaches taken in the art have been the use of organic-inorganic carbon/graphite composites, and the use of solid carbons or graphites. As an example of the former, carbon powder and graphitic fibers or cloth may be mixed with a reinforcing agent or binder in a more ductile matrix, such binder comprising for example a resin or plastic material. Solid carbon/graphite electrodes may be formed of high temperature sintering of carbon or graphite powders, flakes or other carbonizable materials with binders, such as oil, pitch or tar. These materials are mixed, then extruded, shaped or molded and then fired to a temperature to carbonize the binder. Further firing at a higher temperature may be carried out to graphitize the mass. The present invention adopts the first approach in using organic-inorganic carbon/graphite composites, which offer significant advantages in manufacturing efficiency by avoiding the need for a series of time consuming (typically several hours each) process steps, and by avoiding high temperature (2000-3000° C.) production processes.

Another problem to be considered in the choice of suitable materials for water transport plates is the risk of “poisoning” the catalyst system of the membrane electrode assembly or MEA. It is therefore desirable to avoid migratory species in the plate body or any surface coatings of the plate that may be leached during fuel cell operation to cause such poisoning.

Additional prior art references include U.S. Pat. Nos. 6,197,442 B1; 4,826,741; and 5,942,347.

U.S. Pat. 6,197,442 B1: Method of Using a Water Transport Plate

Novel water transport plates made by mixing graphite powder, reinforcing fibers, cellulosic fibers and thermosetting resin to form a planar sheet that is carbonized and graphitized to form a plate blank. The blank is then machined to the required thickness and to form coolant and reactant flow channels. The machined plate is then treated with a wettability preserving compound taken from the group consisting of oxides or hydroxides of metals (compare U.S. Pat. No. 5,840,414). There are various tedious steps involved in this process which are both time consuming and involving high temperatures (2000-3000° C.) making this a commercially unattractive method to produce water transport plates.

U.S. Pat. No. 4,826,741: Ion Exchange Fuel Cell Assembly with Improved Water and Thermal Management

Reactant distribution plate made of porous graphite or carbon is rendered hydrophilic by impregnating with colloidal silica (compare U.S. Pat. No. 4,175,165). Plates made in this fashion may perform satisfactorily for a limited period, but the product water percolating through the plate will leach the silica out of the plate resulting in a loss of hydrophilic properties.

U.S. Pat. No. 5,942,347: Proton Exchange Membrane Fuel Cell Separator Plate

Gas impervious bipolar separator plate comprising an electronically conductive material, resin and a hydrophilic agent dispersed uniformly throughout the plate. Preferred electrically conductive material is graphite and in addition carbon fibers may be present to strengthen and promote water absorption. Hydrophilic resins such as phenol-formaldehyde thermosetting resin is preferred as the binder, and the plate material further includes a wetting agent selected from the group consisting of oxides of Ti, Al, Si and mixtures thereof. Although this plate provides for an efficient way to fabricate water transport plates, the addition of the wetting agent considerably increases the plate resistance, lowering cell efficiency. The wetting agents could also reduce the flexural strength of the plates and cause failures due to plates cracking.

For completeness, the technical disclosures of each of the foregoing cited patents are incorporated by reference into this specification.

### INVENTION SUMMARY

From a consideration of the foregoing prior art references, it appears that the following properties are desirable in separator or water transport plates:

1. High electrical conductivity. or low electrical resistance.

2. Good mechanical strength.

3. Wettability, or hydrophilic properties.

4. Porosity and good permeability.

5. Simple and inexpensive manufacturing steps.

6. Stability, durability and inertness.

In accordance with one illustrative preferred embodiment of the invention, the foregoing desirable features and properties are achieved by forming a separator plate or WTP using (1) conductive powder, such as graphite; (2) conductive fibers, such as carbon fibers; and (3) an inert, electrochemically stable binder which has good wettable or hydrophilic properties. Preferably, the conductive powder is graphite, the conductive fibers are carbon fibers, and the binder is a thermosetting binder.

In some cases the binder may have its hydrophilic properties improved by a simple oxidation process, for examples, by immersing the molded plate for several minutes in a bath of sodium hypochlorite (NaOCl) or sulfuric acid (H₂SO₄), and then thoroughly rinsing the plates with water. Other oxidizing agents can be used.

More specifically, the plates are typically three (3) component plates with about 50 to about 80% by weight of conductive powder, about 5% to about 20% by weight of conductive fibers and about 15% to about 30% of binder such as a thermosetting resin. Preferably, the plates contain about 60% to about 75% of conductive powder, about 10% to about 15% of conductive fibers, and about 15% to about 25% of binder. The density of the plates is about 1.1 g/cc as compared with the density of carbon which is about 2.5 g/cc, indicating the significant porosity of the plates.

In practice the plates are formed by molding under elevated pressure and heat, with an optional additional oxidation treatment to increase hydrophilic properties.

Other objects, features and advantages of the invention will become apparent from a consideration of the following detailed description, and from the accompanying drawings.

### BRIEF DESCRIPTION OF THE DRAWINGS

FIG. 1 is a schematic showing of a fuel cell system; and

FIG. 2 is a more detailed showing of a fuel cell stack showing the Polymer Electrolyte Membrane and the water transport plates.

### DETAILED DESCRIPTION OF THE PREFERRED EMBODIMENTS

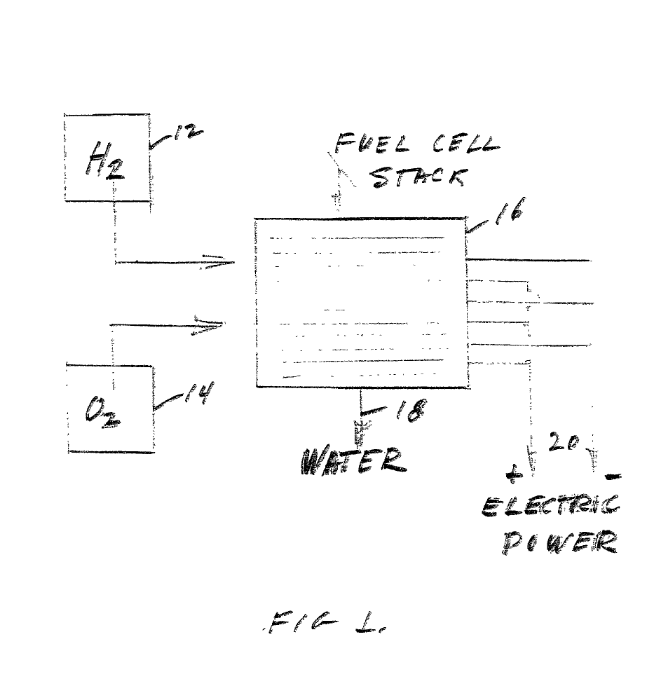

Referring more particularly to the drawings, FIG. 1 is a schematic showing of a fuel cell system. The system of FIG. 1 includes a source of hydrogen gas 12, a source of oxygen 14, which could be atmospheric air, and a fuel cell stack 16 which includes polymer electrolyte membranes (PEM) and separators, or water transport plates, as discussed below. The hydrogen and oxygen are combined, producing water as indicated by reference number 18, and electricity as indicated at reference numeral 20.

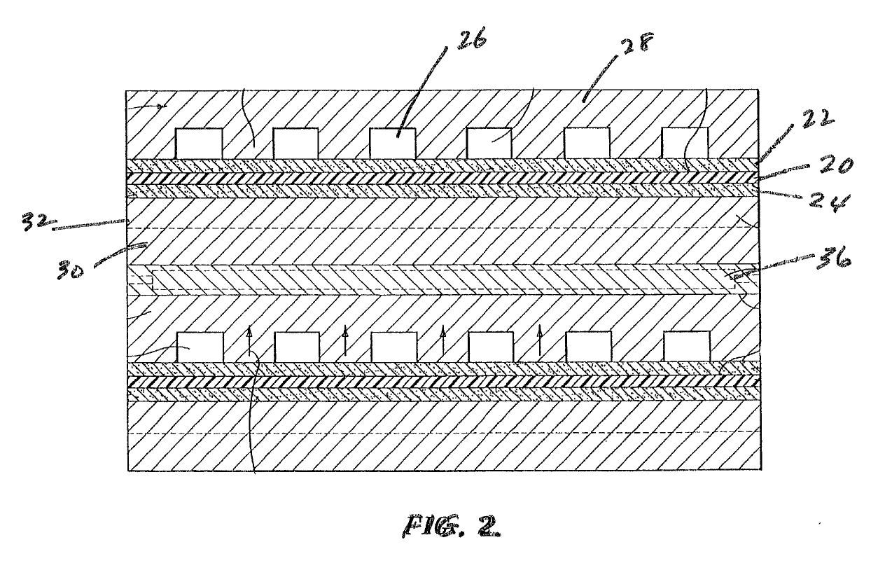

FIG. 2 is taken from U.S. Pat. No. 5,840,414, and provides background information indicating the importance of various properties of water transport plates. Briefly, the fuel cell stack as shown in FIG. 2 includes the polymer electrolyte membrane 20, the porous cathode catalyst 22 and the porous anode catalyst 24 on the two sides of the membrane 20. Hydrogen gas is supplied through the channels 26 of the upper separator plate 28, and oxygen gas is supplied to the channels 30 of the lower separator plate 32, with the channels 30 running perpendicular to the channels 26. The hydrogen and oxygen combine, producing water and electricity. Coolant water flows through channel 36. Additional membranes and separator plates are included in the stack, and the electrochemical reaction is taking place concurrently at various levels in the stack.

For completeness, it is useful to consider the chemistry of a polymer electrolyte membrane (or proton exchange membrane) fuel cell, as follows:

On the anode side:

2H₂=>4H⁺+4e⁻

On the cathode side:

O₂+4H⁺+4e⁻=>2H₂O

The net reaction:

2H₂+O₂=>2H₂O

A more complete description of the fuel cell operation is presented in U.S. Pat. No. 5,840,414. It is noted that the foregoing description of fuel cell operation is given primarily by way of background, as the present invention relates primarily to the construction of the separator or water transport plates for use in fuel cell systems.

As set forth in part of the introduction of this application, the typical composition of the fuel cell separators or water transport plates is about 50% to about 80% by weight of conductive powder, about 5% to 20% by weight of conductive fiber, and about 15% to about 30% by weight of binder. Preferably, the composition of fuel cell separators or water transport plates according to the present invention is about 60% to about 75% by weight of conductive powder, about 10% to about 15% by weight of conductive powder, and about 15% to about 25% by weight of binder. We will now consider various aspects of these materials, and the resultant plates in greater detail.

Materials

a) Conductive Powders—

i) Preferably, the conductive powder is graphite. High purity graphite is the most preferred material; it provides excellent conductivity and inertness. Alternatively, the conductive powder can comprise other materials such as surface metallized hollow particles. An example of such surface metallized hollow particles is hollow glass particles that are coated with silver.

ii) Types of graphite used include purified forms of natural crystalline vein, natural crystalline flake, synthetic flake with at least 99.8% carbon content; ultra pure natural crystalline flake with at least 99.95% carbon content is the preferred form.

iii) Particle size distribution of the graphite powder used is more than 90% passing through 200 Tyler mesh, equivalent to 90% particles less than about 80 μm in size. Preferred size distribution is at least 99% passing through 325 mesh or less than about 45 μm in size. Incidentally, the symbol “μm” signifies “micron”, and a micron is equal to 10⁶ meter.

b) Conductive Fibers—

i) Preferably, the conductive fibers are carbon fibers. Carbon fibers derived from graphitization of polyacrylonitrile (PAN) fibers are most suitable for the purpose. They provide improved conductivity at low levels. A high temperature process providing at least 95% carbon content, ultra pure fibers with 99+% carbon content is preferred for the inertness of the fibers produced by the process. Other types of carbon fibers such as exfoliated graphite fibers can alternatively be used. Other types of conductive fibers other than carbon fibers also can be used in place of carbon fibers.

ii) Milled fibers with average fiber length between 150 μm-300 μm provide the best conductivity; chopped fibers with lengths as low as 0.125″ provide good balance of conductivity and strength but are more difficult to disperse. Preferably, the fibers have a diameter of from about 5 μm to about 10 μm and have an aspect ratio of from about 20 to about 50.

iii) Fibers can be further sized to obtain specific characteristics such as to improve compatibility with binder or increase fiber strength.

c) Binders—

i) A key requirement for the binder material is that it has to be wettable to water, this enables the plate to function as a water transport plate more efficiently.

ii) Various thermoplastic and thermosetting materials that are inherently wettable and are acceptable for use in fuel cell include polycarbonates, polysulfones, phenolics, epoxy, nylons, polyesters, polyimides, polyetheresters, polyetheramides, polyethersulfones, cellulose acetate, aliphatic polyurethanes, polyacrylonitriles, polytetrafluoroethylenes, polyvinylidene fluorides, polytetrafluoroethylenes, HDPEs, and poly(methyl α-methacrylates). Other thermoplastic and thermosetting polymers can be used as binder materials, including polymers formed by free radical and addition reactions. Mixtures or blends of binders can also be used. Typically, the binder is a thermosetting binder, but thermoplastic binders can also be used as described above.

iii) Phenolic resins are the preferred binder materials because they are compatible with the graphite and carbon fiber and provide excellent dimensional stability and strength.

iv) Single stage phenolic resins also known as Resol are particularly preferred as the binder and comprises resins based on phenol-formaldehyde, bisphenol-A-formaldehyde, bisphenol-F-formaldehyde and suitable mixtures thereof. A preferred inherently wettable Resol contains phenol-formaldehyde polymer with up to 7% free phenol.

An important criterion in binder selection is its electrochemical inertness, that is, the absence of components that can lower the cell performance. An example of an unsuitable binder is the hexa cured novolacs, which on curing produce ammonia as a by-product, which then gets leached out of the plate, lowering membrane conductivity and poisoning the catalyst through well known mechanisms. Another example is the use of phenol based powdered resols that contain amine compounds which can produce similar results.

Plate Formulation and Examples

Preferably, plates according to the present invention have low resistivity. A preferred value for resistivity is less than 0.2 ohm-cm. Preferably, plates according to the present invention are free from wetting agents that can cause deterioration of the flexural strength of the plate. As used herein, the term “wetting agents” includes, but is not limited to, oxides of titanium, silica, alumina, and alumina-silica compositions. As used herein, the term “wetting agents” excludes ingredients of the plate that are integral with one or more of the following plate components: the conductive powder, the conductive fibers, and the electrochemically stable binder. By way of illustration, an oxidized binder, which is integral with the electrochemically stable binder, is not a “wetting agent.” Such wetting agents can also leach and “poison” the catalyst when used. Preferably, the flexural strength of the plate is at least 20 Mpa or about 3000 psi. The heat and pressure required to produce the plate are low relative to what is required to produce carbonization. Typically, the curing temperature of the plate is about 400° F., while 2000-3000° F. is required for carbonization. In general, plates according to the present invention have water permeability of greater than 25×10⁻¹⁶ m², bubble pressure of greater than 7 psi or about 48 kPa, and water take-up of greater than 80%. Typically, plates according to the present invention have a median pore size of 0.4 to 5.0 μm, with at least 50% pores by volume below 3.0 μM in size. Typically, the plate is stiff and provided with continuous flow channels on one or both faces of the plate. Typically, plates according to the present invention are molded by using heat and pressure sufficient to form a porous and hydrophilic plate; if a thermosetting binder is used, the heat and pressure is sufficient to crosslink the binder.

The following examples illustrate the findings:

Materials Used

i) Graphite: Supplier—Superior Graphite, Chicago, Ill.

Grades—2935APH, Purified Natural Crystalline Flake, 99%<325 mesh (45 μm) 5535, Purified Synthetic Flake, 99%<325 mesh (45 μm) LBG-73, Purified Natural Crystalline Flake, 90%<200 mesh (79.3 μm)

ii) Carbon Fiber: Supplier—Zoltek, St. Louis, Mo.

Grade—Panex 30, High Purity Milled Fibers, Fiber mean length 150 μm Panex GL200, High Purity Milled Fibers, Fiber Mean Length 200 μm

iii) Phenolic Resin: Supplier—Plastics Engineering Company, Sheboygan, Wis.

Grade—Plenco 13394, Resol, Single Stage Phenol-Formaldehyde Resin Plenco 12780, Resol, Single Stage Bisphenol A-Formaldehyde Resin Plenco 13299 Novolac, Two Stage Phenol-Formaldehyde Resin

Plate Making Process:

i) Carefully weighed amounts of the three components: graphite, carbon fiber and binder, were placed in a glass container.

ii) The components were then tumble mixed using a non contact shaker mixer for about 30 mins.

iii) An aluminum mold with a 5″×5″×0.1 ″ cavity was used to form the plate. Prior to charging, the mold was prepared by cleaning thoroughly and coating the walls with a uniform layer of release agent. The release agent was selected from a wide range of commercially available products to provide easy removal of the molded plate without any or minimal contamination of the part.

iv) A predetermined amount of the mixture was weighed depending on the desired plate density and transferred uniformly into the mold cavity.

v) The mold was then closed and placed in between platens heated to about 400° F. in a hydraulic press and initial force of 10,000 lbs was applied for about 12 seconds to completely pack the mold cavity.

vi) The force was then lowered to about 3,000 lbs and held at 400° F. for about 20 mins to completely cure the binder. The mold was then cooled to below 100° F. and opened to remove the molded plate sample.

vii) The plate was then cleaned with de-ionized water in an ultrasonic cleaner to remove loose particles and contaminants.

Test Method Descriptions

i) Water Permeability: measure of the flow rate of water through the plate so that, in operation, water can pass through the plate in order to remove the product water from the cathode plate. It is expressed as the permeability coefficient of the plate sample over a range of pressure gradients. The permeability of a porous medium is described in Porous Media, Fluid Transport and Pore Structure, 2^{nd} Edition, F. A. L. Dullien, Academic Press, 1992. The flow rate of water through a 16-cm² area of the sample was measured at 1, 3, and 5 psi and the specific permeability (k) was calculated based on the following equation: k=QμL/ΔPA, where Q=flow rate; μ=viscosity of water; L=length of sample in the flow direction, ΔP=pressure differential; and A=normal cross-sectional area of the sample. The results are averaged over the three pressures and reported in 10⁻¹⁶ m².

ii) Bubble Pressure: is the physical characteristic that allows water transport plate to serve as a gas separator and avoid potentially dangerous mixing of the fuel streams. Capillary forces retain the water within the porous structure until the gas to liquid pressure differential exceeds the bubble pressure.

iii) Water Take-up: is a measure of the enhanced wettability of the plate. It is the ratio of water taken up by the plate under ambient pressures to the same under vacuum expressed as percentage.

a) Plate Density: Effect of Density on Permeability and Bubble Pressure

General Density Ranges—

Dense Graphite Plate: 2.2-2.3 g/cc

Porous Graphite Plate: 1.5-1.6 g/cc

Porous Composite Plate: 0.9-1.5 g/cc

Data below illustrates how for a given graphite particle size distribution the density of the plate affects the permeability and bubble pressure. At higher densities (>1.5 g/cc) the bubble pressure increases meaning the plate would be a better gas separator, however this improvement is at the expense of permeability. Hence for a given combination of materials there is an optimum plate density at which the plate performance is maximized.

| | | Water | |
|---|---|---|---|
| | | Permeability | Bubble Pressure |
| Sample | Density, g/cc | 10⁻¹⁶ m² | psi |
| A | 1.10 | 195.05 | 12 |
| B | 1.34 | 51.79 | >15* |

A & B—2935APH, Panex-30, Plenco 13394 (65:15:20)
*—maximum limit on the test equipment

b) Graphite Particle Size Distribution:

Particle size distribution influences the porosity and as a result permeability of the plate.

Data below illustrates this clearly, sample A uses a graphite with finer particle size distribution while samples B & C use a coarser graphite. When plates formed using the two with the same density are tested the plate A with finer particle clearly has a better balance of permeability and bubble pressure. Plate C formed using the coarse graphite with higher density shows comparable permeability but is still poor in bubble pressure. This can be attributed to the large median pore diameter. The data also shows the dependence of water take-up of the plates on the porosity, larger median pore diameter and lesser number of small pores (<3 μm) limit the water take-up.

| | | Water | Bubble | Pore | Median Pore | % Pore Volume | Water |
|---|---|---|---|---|---|---|---|
| | Density, | Permeability | Pressure | Volume | Diameter | <3 μm | Take-up |
| Sample | g/cc | 10⁻¹⁶ m² | psi | mL/g | μm | in size | % |
| A | 1.22 | 140 | 10 | 0.4132 | 2.74 | 56.67 | 95.1 |
| B | 1.22 | 330.93 | 5 | | | | 20.1 |
| C | 1.46 | 114 | 8 | 0.0729 | 4.76 | 18.56 | 51.1 |

A—5535, 99% <325 mesh (45 μm), Panex-30, Plenco 13394
B & C—LBG-73, 90% <200 mesh (79.3 μm), Panex-30, Plenco 13394

c) Optimum Binder Level

Binder level influences the conductivity, permeability and strength properties of the plate. Based on the data from test plates shown in the table below, binder level between 20 and 30% provides the optimum flex stress with excellent permeability and minimum loss of conductivity as indicated by increase in resistance.

| | | | Resistance | Nitrogen | Flex |
|---|---|---|---|---|---|
| | | Thickness | 2″ | Permeability | Stress |
| Sample | Description | inches | ohms | 10⁻¹⁶ m² | MPa |
| A | 10% Binder | 0.132 | 1.1 | 62.8 | 11.486 |
| B | 20% Binder | 0.13 | 1.18 | 105.3 | 25.538 |
| C | 30% Binder | 0.131 | 2.86 | 103.1 | 39.992 |

d) Carbon Fiber Level—

Carbon fiber influences conductivity of the plate significantly and to a lesser extent the permeability and strength especially when using milled fibers. As this is by far the most expensive component its level in the formulation is preferred as low as possible. Fiber levels between 10 and 15% have shown to provide the most impact on the plate conductivity.

e) Carbon Fiber length—

Milled fibers with fiber lengths 150 μm and 200 μm were used at the same level and the longer length provides lower resistivity and better conductivity.

| | | Thru-plane Resistivity |
|---|---|---|
| Sample | Fiber Length (μm) | ohm-cm |
| A | 150 | 0.335 |
| B | 200 | 0.132 |

f) Water Wettability—

The water wettability of the plate is greatly influenced by the hydrophilicity of the binder. Using a hydrophilic binder such as a single stage phenol-formaldehyde resin with up to 7% free phenol compared to a single stage bisphenol-A-formaldehyde binder considerably increases the water uptake of the plate as illustrated from the data below.

| Resol Type | Water contact angle | Water Take-up |
|---|---|---|
| (Cured) | Degrees | % |
| Phenol-formaldehyde (6% free | 70-80 | 90-95 |
| phenol) | | |
| Bisphenol A-formaldehyde | 110-115 | 2-5 |

*—Water take-up measurements were made on porous plates containing about 20% Resol with the rest being Graphite and fiber.

g) Wettability Treatment—

Alternatively, a hydrophobic binder such as the Bisphenol A-formaldehyde resol can be made hydrophilic by suitable treatments. A preferred treatment is to use suitable oxidizing agents such as Sodium Hypochlorite (NaOCl) or Sulfuric Acid (H₂SO₄) and create hydrophilic groups in the cured resol matrix. Other oxidizing agents can be used to create hydrophilic groups in the cured resol matrix, including chromic acid, potassium permanganate, nitric acid, peroxides, and selenium dioxide, as well as other oxidizing agents known in the art.

The treatment was carried out in the following fashion:

Sodium Hypochlorite (NaOCl Treatment): 1.9 M NaOCl (available from Aldrich, Milwaukee, Wis.) was diluted with deionized water to form a 5.25% NaOCl treatment solution. Plate molded in the fashion described earlier containing:

| | | |
|---|---|---|
| Graphite | Thermapure 2935APH1 | 65% by weight |
| Fiber | Panex 200GL | 15% by weight |
| Resin | Plenco 12780 | 20% by weight |

was immersed for a predetermined period of time depending on the desired level of hydrophilicity. In a set of controlled experiments samples tested showed saturation in water take-up after about 5 min of treatment. The plates were then removed and thoroughly rinsed with deionized water until absence of residual chlorine was confirmed using 0.1 M silver nitrate solution.

Sulfuric Acid (H₂SO₄) Treatment: 6 M H₂SO₄ (available from Mallinckrodt, Paris, Ky.) was used in its original concentration. Molded samples with the composition described above were immersed in the acid for a predetermined period of time depending on the desired level of hydrophilicity. In a set of controlled experiments samples tested showed saturation in water take-up after about 1 min of treatment. The plates were then removed and thoroughly rinsed with de-ionized water until absence of residual acid was confirmed using 0.1 M barium chloride solution.

Table below show the effect of the above mentioned treatments on the surface tension and water uptake measurements.

| Bisphenol A-Formaldehyde | Water contact angle | Water Take-up |
|---|---|---|
| (Cured) | Degrees | % |
| Sample A—untreated | 110-115 | 2-5 |
| Sample B—10 min. NaOCl 5.25% | 70-80 | 75-85 |
| Sample C—1 min. 6 M H₂SO₄ | 60-65 | 85-95 |

The treatments described provide permanent and durable effect and unlike the hydrophilic coatings described in prior art do not get leached out. Data below shows that boiling the treated plate for an extended period of time does not affect the water take-up of the plate.

| | Water Take-up |
|---|---|
| Plate Samples | % |
| A—Untreated | 4.4 |
| B—5 min. NaOCl 5.25% | 86.8 |
| C—Sample B Boiled in DI Water | 85.7 |
| overnight | |

Also, treatments do not influence any other plate characteristics and there is no loss in plate conductivity or strength due to these treatments as seen from the data below.

| | Thru-plane Resistivity | Flex Stress |
|---|---|---|
| Plate Samples | ohm-cm | MPa |
| Sample (A)—untreated | 0.14 | 20.8 |
| Sample (B)—10 min. NaOCl | 0.13 | 19.9 |
| 5.25% | | |

Treatment does not have an influence on pure graphite plate or completely inorganic plates as illustrated by the data below on porous graphite plate.

| | Water Take-up |
|---|---|
| Sample | % |
| Porous graphite plate untreated | 1.3 |
| Porous graphite plate—10 min. NaOCl | 2.3 |
| 5.25% | |

h) Best Mode Example:

A 2″ by 2″ plate section was cut from the sample molded with the following composition:

| | | |
|---|---|---|
| Graphite | Thermapure 2935APH | 65% by wt |
| Fiber | Panex 200GL | 15% by wt |
| Resin | Plenco 12780 | 20% by wt |

The sample was immersed in 5% Sodium hypochlorite solution for 5 to 10 mins, removed and rinsed thoroughly. The sample was then tested to have the following properties:

| | Thru-plane | Water | Bubble | Water | Flex |
|---|---|---|---|---|---|
| Density | Resistivity | Permeability | Pressure | Take-up | Stress |
| g/cc | ohm-cm | 10⁻¹⁶ m² | psi | % | MPa |
| 1.22 | 0.132 | 82.56 | 15 | 95.60 | 19.95 |

Conceptual manufacturing scheme for producing large quantities of plates: The plate composition is formulated and mixed using a variety of commercially available mixing equipment in either a batch or continuous fashion; non-contact mixing techniques are particularly preferred. The composition can then optionally be preformed into either a bulk molding compound (BMC) or granulated form or in a sheet molding compound form (SMC). Preforming the formulation is common practice in the plastics forming area and makes handling and storage of the composition easier. The compositions can be formed by a variety of methods including but not limited to compression, transfer, and injection molding. Compression molding is more preferable when using thermosetting binder types.

For compression molding, accurately weighed plate composition in powder form or the preform is preheated to just below the curing temperature and placed between the mold platens heated to above the curing temperature. The platens are then closed at appropriate pressures to form the cured plate. Typical cycle times for the process vary from about 50 to about 150 seconds. Multiple mold cavities can be used to provide high plate throughputs. Molds can be designed to form flow channels on either one face or both faces of the plate to provide pathways for the reactants and product water. The typical post-machining steps required to create these channels can be avoided in this manner.

Post molding treatments can be accomplished by a variety of methods including continuous belts moving through the treating and rinsing stations or batch processes involving treatment and cleaning tanks and followed by a drying step.

2) Other Illustrations with no Significant Results:

a) Dry molding of wet formulated powder with thermoplastic amphiphilic binders having a random co-continuous assemblage of hydrophilic and hydrophobic chains that are able to swell in both water and hydrocarbons.

The amphiphilic binders used were:

i) Butvar B-90 from Monsanto, which is a terpolymer of vinyl butyral, vinyl alcohol, and vinyl acetate. The binder was dissolved in isopropanol to make 5% binder solution. (PVB)

ii) Poly (1-vinylpyrrolidone-co-styrene), 38% emulsion in water, from Aldrich. (PS)

Samples showed either low permeability or low bubble pressure values, it was not possible to obtain a balance between the two.

| | Density | Water Permeability | Bubble Pressure |
|---|---|---|---|
| Sample | g/cc | 10⁻¹⁶ m² | psi |
| A: Graphite + PVB + | 1.38 | 5.1 | 1.1 |
| PS | | | |
| B: Graphite + Fiber + | 1.39 | 63 | 3.5 |
| PVB + PS | | | |
| C: Graphite + Fiber + | 1.45 | 147 | 1 |
| PVB + PS + Silica | | | |
| D: Graphite + PVB + | 1.38 | 55 | 1 |
| PS + Clay | | | |
| E: Graphite + Fiber + | 1.38 | 17 | 9 |
| PVB + PS + Clay | | | |

b) Blends of thermosets and thermoplastics resins as binders—

Samples were weak as shown by their low flex stress values.

| | | | Bubble | Flex |
|---|---|---|---|---|
| | Density | Water Permeability | Pressure | Stress |
| Sample | g/cc | 10⁻¹⁶ m² | psi | MPa |
| A: Graphite + Fiber + | 1.16 | 37.15 | 15 | 10.23 |
| Phenolic + PVB | | | | |

c) Thermoplastic binder injection molded—

Graphite and polypropylene (PP) were compounded and granulated in a twin screw extruder along with some low melting wax as process aid. To enable processing the minimum binder level required was around 30%. The granules were then injection molded to form plates. As indicated by their permeability data the plates did not have any porosity and their conductivity was very poor.

| | Thru-plane Resistivity | Water Permeability |
|---|---|---|
| Sample | ohm-cm | 10⁻¹⁶ m² |
| A: Graphite + | 1.36 | 0 |
| PP + Wax | | |

d) Blending water soluble polymers in the formulation—

About 4-5% of a water soluble polymer such as Methylhydroxypropylcellulose and Hydroxyethylcellulose was added to the formulation, the resulting plates did not show a significant improvement in the permeability but lowered the bubble pressure in the process.

| | Water Permeability | Bubble Pressure |
|---|---|---|
| Sample | 10⁻¹⁶ m² | psi |
| A: Graphite + Fiber + | 58.66 | 7 |
| Phenolic + | | |
| Methylhydroxypropylcellulose | | |
| B: Graphite + Fiber + | 90.71 | 5 |
| Phenolic + | | |
| Hyrdoxyethylcellulose | | |

e) Addition of amino-compounds in the formulation

Trace amounts (<1%) of amino compounds: 2-amino-1,3-propanediol and 6-amino-1-hexanol were added to the formulation and formed into plates. The resulting plates showed very poor physical appearance with visible surface defects and also when immersed in water there was detectable amounts of material that was leached out of the plate.

In closing, it is to be understood that the foregoing detailed description and the accompanying drawings relate to preferred embodiments of the invention. Various changes and modifications are within the scope of those skilled in the art. Thus, by way of example and not of limitation, varying proportions of graphite and carbon fibers may be used, with a lesser percentage of carbon fiber reducing the conductivity of the plates, and increasing the percentage of carbon fibers to up to 30 percent would lower the resistance, but would substantially increase the costs. Concerning binders, inert thermosetting binders are to be preferred as involving cross-linking and maintaining high porosity; but other inert binders including thermoplastic binders could also be employed, as long as they have good hydrophilic properties either inherently or following surface oxidation treatment. The binders may include two compatible binders, and when reference is made to “binders” it is to be understood that two or more compatible binders may be included in this designation. Concerning particle size, substantial variations from the preferred sizes may reduce efficiency to a minor extent, but would still provide operable water transport plates. Accordingly, the present invention is not limited to the embodiments described in detail hereinabove.

We claim:

1. A method of forming a fuel cell separator or water transport plate comprising the steps of:
mixing together the following materials in the indicated weight proportions:
(a) about 50% to about 80% of conductive powder;
(b) about 5% to about 20% of conductive fibers;
(c) about 15% to about 30% of a electrochemically inert binder; and
molding a plate from the foregoing mixture using heat and pressure sufficient to form a porous and hydrophilic plate.

2. A method as defined in claim 1 further comprising the step of applying an oxidizing agent to the plate to increase the hydrophilic properties thereof.

3. A method as defined in claim 2 wherein the oxidizing agent is selected from the group consisting of sodium hypochlorite, sulfuric acid, chromic acid, potassium permanganate, nitric acid, peroxides, and selenium dioxide.

4. A method as defined in claim 1 further comprising the steps of applying to the plate an oxidizing fluid selected from the group consisting of sodium hypochlorite and sulfuric acid, and rinsing the plate with water.

5. A method as defined in claim 1 wherein the conductive powder is finely divided graphite.

6. A method as defined in claim 1 wherein the conductive fibers are carbon fibers.

7. A method as defined in claim 1 wherein the electrochemically inert binder is a thermosetting binder.

8. A method as defined in claim 1 wherein the weight proportion of the conductive powder is about 60% to about 75%, the weight proportion of the conductive fibers is about 10% to about 15%, and the weight proportion of the electrochemically inert binder is about 15% to about 25%.

9. A method as defined in claim 1 wherein the conductive particles are finely divided graphite, the conductive fibers are carbon fibers, and the electrochemically inert binder is a thermosetting binder, and the step of molding the plate uses heat and pressure sufficient to crosslink the binder.

10 A method as defined in claim 9 wherein the weight proportion of the finely divided graphite is about 60% to about 75%, the weight proportion of the carbon fibers is about 10% to about 15%, and the weight proportion of the electrochemically inert thermosetting binder is about 15% to about 25%.

11. A method as defined in claim 9 wherein the mixing step includes mixing graphite having a size of about 45 microns or less, and carbon fibers having an average length between about 150 μm and 300 μm.

12. A method as defined in claim 1 wherein said mixing step includes mixing at least two binder materials having the total weight percentage of between about 15% and about 30%.

13. A method as defined in claim 1 wherein the mixing steps include the listed components as the only ingredients affecting performance of the plate in a fuel cell assembly.

14. A method as defined in claim 1 wherein the plate is substantially free from a wetting agent.

15. A method as defined in claim 9 wherein the carbon fibers have a diameter of from about 5 μm to about 10 μm and have an aspect ratio of from about 20 to about 50.

16. A method as defined in claim 1 wherein the plate has a resistivity of less than about 0.2 ohm-cm.

17. A method as defined in claim 1 wherein the plate has water take-up of at least about 80%.

18. A method as defined in claim 7 wherein the thermosetting binder is a phenolic resin.

19. A method as defined in claim 18 wherein the phenolic resin is a phenol-formaldehyde resin.

20. A fuel cell separator or water transport plate comprising:
a stiff ridged plate formed of about 50% to about 80% by weight of conductive powder, about 5% to about 20% by weight of conductive fibers, and about 15% to about 30% by weight of a electrochemically inert binder;
said plate being porous and having a hydrophilic or wettable surface.

21. A fuel cell separator or water transport plate as defined in claim 2 wherein the entire surface of said plate including the surface of the pores thereof is oxidized.

22. A fuel cell separator or water transport plate as defined in claim 20 wherein said binder is made up of two distinct binder materials.

23. A fuel cell separator or water transport plate as defined in claim 20 wherein the plate comprises only materials affecting performance of the plate in a fuel cell assembly.

24. A fuel cell separator or water transport plate as defined in claim 21 wherein the oxidation is performed by reacting with an oxidizing agent selected from the group consisting of sodium hypochlorite, sulfuric acid, chromic acid, potassium permanganate, nitric acid, peroxides, and selenium dioxide.

25. A fuel cell separator or water transport plate as defined in claim 20 wherein the conductive powder is finely divided graphite.

26. A fuel cell separator or water transport plate as defined in claim 20 wherein the conductive fibers are carbon fibers.

27. A fuel cell separator or water transport plate as defined in claim 20 wherein the electrochemically inert binder is a thermosetting binder.

28. A fuel cell separator or water transport plate as defined in claim 20 wherein the weight proportion of the conductive powder is about 60% to about 75%, the weight proportion of the conductive fibers is about 10% to about 15%, and the weight proportion of the electrochemically inert binder is about 15% to about 25%.

29. A fuel cell separator or water transport plate as defined in claim 20 wherein the conductive particles are finely divided graphite, the conductive fibers are carbon fibers, and the electrochemically inert binder is a thermosetting binder, and the step of molding the plate uses heat and pressure sufficient to crosslink the binder.

30. A fuel cell separator or water transport plate as defined in claim 29 wherein the weight proportion of the finely divided graphite is about 60% to about 75%, the weight proportion of the carbon fibers is about 10% to about 15%, and the weight proportion of the electrochemically inert thermosetting binder is about 15% to about 25%.

31. A fuel cell separator or water transport plate as defined in claim 20 wherein the plate is substantially free from a wetting agent.

32. A fuel cell separator or water transport plate as defined in claim 29 wherein the carbon fibers have a diameter of from about 5 μm to about 10 μm and have an aspect ratio of from about 20 to about 50.

33. A fuel cell separator or water transport plate as defined in claim 20 wherein the plate has a resistivity of less than about 0.2 ohm-cm.

34. A fuel cell separator or water transport plate as defined in claim 20 wherein the plate has water take-up of at least about 80%.

35. A fuel cell separator or water transport plate as defined in claim 27 wherein the thermosetting binder is a phenolic resin.

36. A fuel cell separator or water transport plate as defined in claim 35 wherein the phenolic resin is a phenol-formaldehyde resin.

37. A fuel cell separator or water transport plate made by the method of claim 1.

38. A fuel cell separator or water transport plate as defined in claim 25 wherein the particle size of the graphite is less than about 45 microns in size, or wherein more than 90% of the graphite will pass through a 325 mesh size screen.

39. A fuel cell separator or water transport plate as defined in claim 26 wherein the carbon fibers have an average fiber length of between 150 and 300 microns.

40. A method of forming a fuel cell separator or water transport plate comprising the steps of:
mixing together the following materials in the indicated weight proportions:
(a) about 50% to about 80% of conductive powder;
(b) about 5% to about 20% of conductive fibers;
(c) about 15% to about 30% of a powdered electrochemically inert binder;
molding a water transport plate from the foregoing mixture using heat and pressure sufficient to form a porous plate with hydrophilic or wettable surface including through the pores thereof, and
subjecting the plate to oxidation to increase the hydrophilic properties thereof.

41. A method as defined in claim 40 wherein the step of subjecting the plate to oxidation is performed by contacting the plate with an oxidizing agent that is selected from the group consisting of sodium hypochlorite, sulfuric acid, chromic acid, potassium permanganate, nitric acid, peroxides, and selenium dioxide.

42. A method as defined in claim 40 wherein the oxidation step utilizes an oxidizing fluid selected from the group consisting of sodium hypochlorite and sulfuric acid, and rinsing the plate with water.

43. A method as defined in claim 40 wherein the conductive powder is finely divided graphite.

44. A method as defined in claim 40 wherein the conductive fibers are carbon fibers.

45. A method as defined in claim 40 wherein the powdered electrochemically inert binder is a thermosetting binder.

46. A method as defined in claim 40 wherein the weight proportion of the conductive powder is about 60% to about 75%, the weight proportion of the conductive fibers is about 10% to about 15%, and the weight proportion of the electrochemically inert binder is about 15% to about 25%.

47. A method as defined in claim 40 wherein the conductive particles are finely divided graphite, the conductive fibers are carbon fibers, and the electrochemically inert binder is a thermosetting binder, and the step of molding the plate uses heat and pressure sufficient to crosslink the binder.

48 A method as defined in claim 47 wherein the weight proportion of the finely divided graphite is about 60% to about 75%, the weight proportion of the carbon fibers is about 10% to about 15%, and the weight proportion of the electrochemically inert thermosetting binder is about 15% to about 25%.

49. A method as defined in claim 47 wherein the mixing step includes mixing graphite having a size of about 45 microns or less, and carbon fibers having an average length between about 150 microns and 300 microns.

50. A method as defined in claim 40 wherein the plate is substantially free from a wetting agent.

51. A method as defined in claim 44 wherein the carbon fibers have a diameter of from about 5 μm to about 10 μm and have an aspect ratio of from about 20 to about 50.

52. A method as defined in claim 40 wherein the plate has a resistivity of less than about 0.2 ohm-cm.

53. A method as defined in claim 40 wherein the plate has water take-up of at least about 80%.

54. A method as defined in claim 40 wherein the thermosetting binder is a phenolic resin.

55. A method as defined in claim 40 wherein the phenolic resin is a phenol-formaldehyde resin.

56. A fuel cell separator or water transport plate comprising:
a plate formed of 50% to 80% by weight of finely divided graphite, 5% to 20% of carbon fibers, and 15 to 30% of an electrochemically inert binder;
said plate being porous and having a hydrophilic or wettable surfaces; the foregoing listed ingredients being the only ingredients affecting performance of the plate in a fuel cell assembly included in the plate.

57. A fuel cell separator or water transport plate as defined in claim 56 wherein the entire surface of said plate including the surface of the pores thereof is oxidized.

58 A fuel cell separator or water transport plate as defined in claim 57 wherein the oxidation is performed by reacting with an oxidizing agent selected from the group consisting of sodium hypochlorite, sulfuric acid, chromic acid, potassium permanganate, nitric acid, peroxides, and selenium dioxide.

59. A fuel cell separator or water transport plate as defined in claim 56 wherein the carbon fibers have a diameter of from about 5 μm to about 10 μm and have an aspect ratio of from about 20 to about 50.

60. A fuel cell separator or water transport plate as defined in claim 56 wherein the plate is substantially free from a wetting agent.

61. A fuel cell separator or water transport plate as defined in claim 56 wherein the plate has a resistivity of less than about 0.2 ohm-cm.

62. A fuel cell separator or water transport plate as defined in claim 56 wherein the plate has water take-up of at least about 80%.

63. A fuel cell separator or water transport plate as defined in claim 56 wherein the plate consists essentially of materials affecting performance of the plate in a fuel cell assembly, and the plate is free of metal oxides or other outer coatings.

64. A fuel cell separator or water transport plate as defined in claim 56 wherein the density of the plate is between 0.8 and 1.5 g/cc.

65. A fuel cell separator or water transport plate as defined in claim 56 wherein the electrochemically inert binder is a thermosetting binder.

66. A fuel cell separator or water transport plate as defined in claim 65 wherein the thermosetting binder is a phenolic resin.

67. A fuel cell separator or water transport plate as defined in claim 66 wherein the phenolic resin is a phenol-formaldehyde resin.

68. A fuel cell separator or water transport plate made by the method of claim 40.

69. An assembly comprising:
(a) a fuel cell plate as defined in claim 56; and
(b) a membrane electrode assembly mounted adjacent to the fuel cell plate.
